(19) United States
(12) Patent Application Publication
(10) Pub. No.: US 2006/0238419 A1
(43) Pub. Date: Oct. 26, 2006

(54) Method and apparatus for aiding positioning of a satellite positioning system and receiver

(76) Inventors: Brian E. Bucknor, Miramar, FL (US); Raziuddin Ali, Weston, FL (US); Russell S. Nelson, Coconut Creek, FL (US); Sergio Bustamante, Pembroke Pines, FL (US)

Correspondence Address: Kevin Wills;Motorola Law Dept, M/O 56-238, 3102 N 56th Street, Phoenix, AZ, 85225, US

(21) Appl. No.: 11/114,468

(22) Filed: Apr. 25, 2005

(51) Int. Cl. G01S 5/14

(52) U.S. Cl. 342/357.09; 342/357.15

(57) ABSTRACT

A satellite positioning system (SPS) receiver (104) operates according to a method (200) having the steps of measuring (201) a distance between the SPS receiver and a transmission source (301) according to a radio frequency (RF) signal transmitted by the transmission source, calculating (212) an approximate location on Earth from the distance and a location of the transmission source, and determining (214) a location fix of the SPS receiver on Earth using the approximate location. Other method and apparatus embodiments are disclosed.

### FIELD OF THE INVENTION

This invention relates generally to satellite positioning systems (SPS), and more particularly, to a method and apparatus for aiding positioning of an SPS receiver.

### BACKGROUND OF THE INVENTION

For a fast location fix, a GPS receiver (also interchangeably referred to as an SPS receiver) relies heavily on the aiding provided by GPS satellite frequency, precise time used by the GPS satellites, approximate position of the GPS receiver, and ephemeris (a table giving the coordinates of a celestial body at a number of specific times during a given period).

The more accurate these parameters are the better the GPS receiver will perform. Typical uncertainty for GPS frequency aiding is +/−0.5 ppm, for precise time +/−100 us, and for approximate position +/−30 Km from a reference point such as a transmission tower. There is very little area for improvement with the frequency and time parameters, but the approximation error on the position of the GPS receiver is quite large and can be improved.

### SUMMARY OF THE INVENTION

Embodiments in accordance with the invention provide a method and apparatus for aiding positioning of an SPS receiver.

In a first embodiment of the present invention, a satellite positioning system (SPS) receiver operates according to a method having the steps of (a) measuring a distance between the SPS receiver and a transmission source according to a radio frequency (RF) signal transmitted by the transmission source, (b) calculating an approximate location on Earth from the distance and a location of the transmission source, and (c) determining a location fix of the SPS receiver on Earth using the approximate location.

In a second embodiment of the present invention, a satellite positioning system (SPS) receiver has a computer-readable storage medium. The storage medium has computer instructions for measuring a distance between the SPS receiver and a transmission source according to a radio frequency (RF) signal transmitted by the transmission source, calculating an approximate location on Earth from the distance and a location of the transmission source, and determining a location fix of the SPS receiver on Earth using the approximate location.

In a third embodiment of the present invention, a selective call radio (SCR) has a radio transceiver for exchanging messages with a communication system, an SPS receiver for locating the SCR on Earth, a memory, and a processor for controlling operations of the memory, the radio transceiver and the SPS receiver. The processor is programmed to measure from the radio transceiver a distance between the SCR and a transmission source of the communication system according to a radio frequency (RF) signal transmitted by the transmission source, calculate an approximate location on Earth from the distance and a location of the transmission source, and cause the SPS receiver to determine a location fix of the SCR on Earth using the approximate location.

### BRIEF DESCRIPTION OF THE DRAWINGS

FIG. 1 is a block diagram of a selective call radio (SCR) in accordance with an embodiment of the present invention;

FIG. 2 is a flow chart depicting a method operating in the SCR in accordance with an embodiment of the present invention;

FIG. 3 depicts aided positioning of the SCR in accordance with an embodiment of the present invention;

FIGS. 4-7 depict the improved performance of locating the SCR with the aid of an approximate location in accordance with an embodiment of the present invention;

FIGS. 8-11 simulated RSSI fading characteristics under static and dynamic conditions at −70 dBm; and

FIG. 12 depicts the line of sight path loss of an RF signal at 860 MHz.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

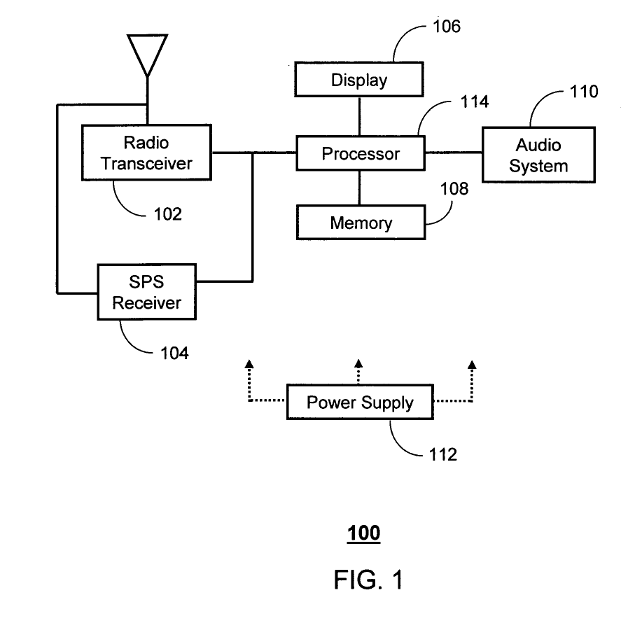

FIG. 1 is a block diagram of a selective call radio (SCR) 100 in accordance with an embodiment of the present invention. The SCR 100 comprises conventional components including a radio transceiver 102 for exchanging messages with a communication system (e.g., a cellular network), an SPS (Satellite Positioning System) receiver 104 for locating a position of the SCR 100 on Earth, a display 106 for conveying images to a user of the SCR 100, a memory 108 including one or more storage elements (e.g., Static Random Access Memory, Dynamic RAM, Read Only Memory, etc.), an audio system 110 for conveying audible signals (e.g., voice messages, music, etc.) to the user of the SCR 100, a conventional power supply 112 for power the components of the SCR 100, and a processor 114 comprising one or more conventional microprocessors and/or digital signal processors (DSPs) for controlling operations of the foregoing components.

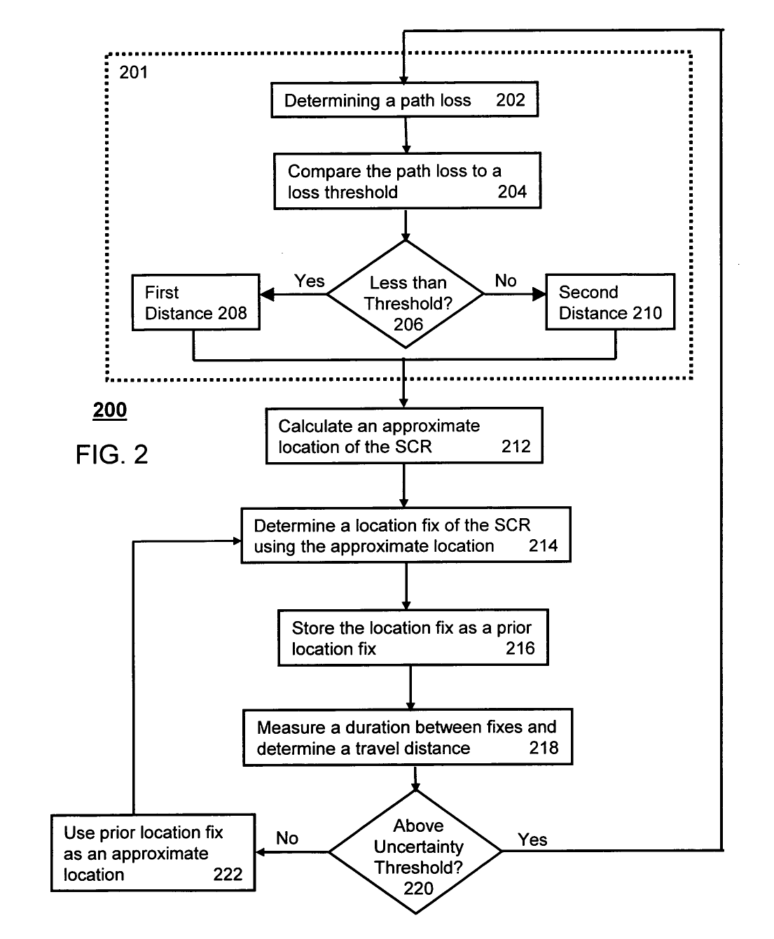

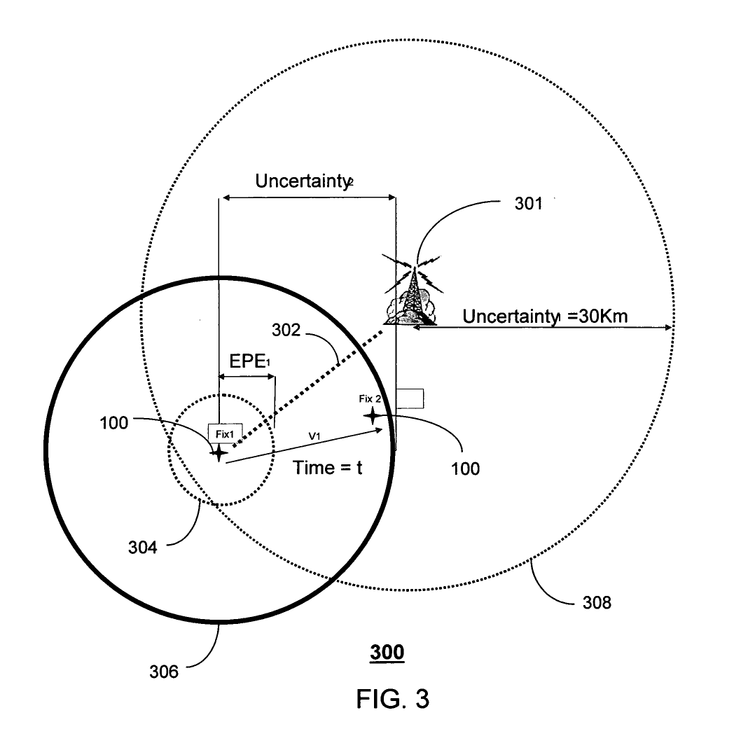

The SCR 100 operates according to method 200 depicted in FIG. 2 in accordance with an embodiment of the present invention. Method 200 begins with step 201 where the SCR 100 measures from information provided by the radio transceiver 102 a distance between the SCR 100 and a transmission source 301 (see FIG. 3 of the communication system according to a radio frequency (RF) signal transmitted by the transmission source 301. Step 201 can be represented by steps 202-210. In step 202 a path loss is determined. The path loss can be determined from a signal strength of the RF signal, a transmission power used by the transmission source 301 to transmit the RF signal, and the location of the transmission source 301.

The signal strength can be determined from an RSSI (Received Signal Strength Indication) reading provided by conventional means used in the radio transceiver 102. The transmission power and the location of the transmission source 301 can be transmitted to the SCR 100 in the RF signal (or from prior signals), or alternatively, can be pre-stored in the memory 108 of the SCR 100 as predetermined information.

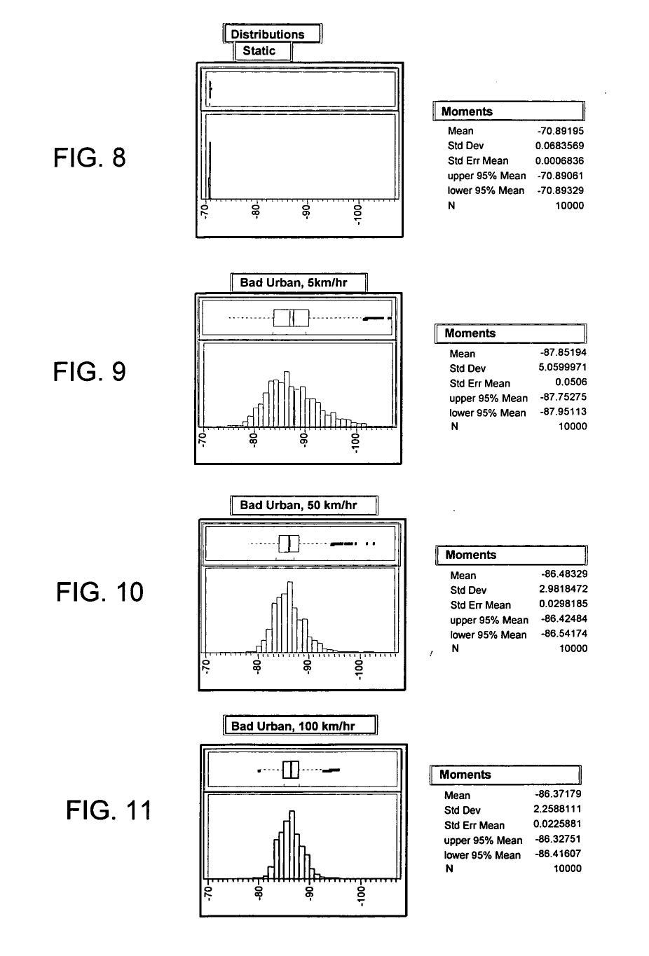

FIGS. 8-11 depict simulations at −70 dBm which expose the SCR 100 to several fading parameters along with a 20 dB co-channel interferer. This data can be used to better understand the variation of RSSI and shifts, if any, in the mean. The data in FIGS. 8-11 shows that for typical fading conditions the mean could shift as much as 17 dB from a static condition (FIG. 8) to a Bad Urban condition (FIGS. 9-11) from a 5 km/hr to a 100 Km/hr fade. From this type of analysis a proper RSSI averaging technique can be developed in step 202.

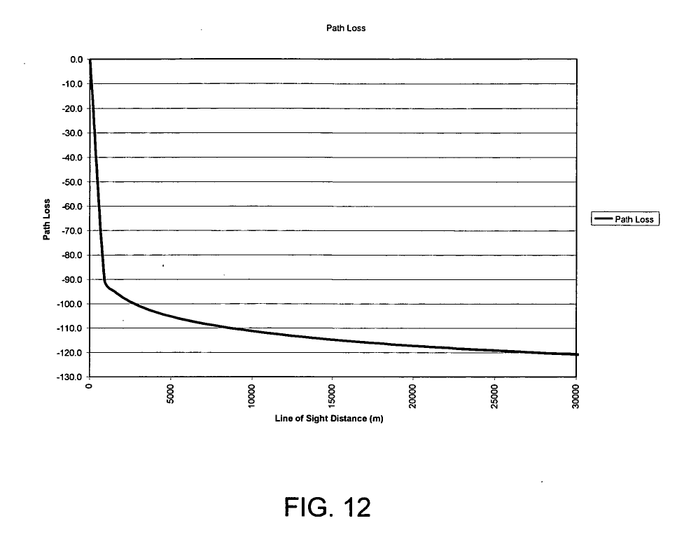

FIG. 12 shows line of site path loss simulations for RF signals operating at a carrier frequency of 860 MHz. Knowing the path loss, a worst-case estimation can be made on distance 302. For example, in step 204 the path loss can be compared to a loss threshold that can be set by a designer of the SCR 100. The loss threshold can be set so that if in step 206 it is determined that the path loss is less than −80 dB then in step 208 a first distance can be determined. The first distance in the present example is chosen conservatively at 5 Km from the transmission source 301. Alternatively, if the path loss is greater than −80 dB, then a second distance can be determined at step 210. In this illustration the second distance is chosen to be a 30 Km (the worst case RF transmission reach of the transmission source 301).

It will be appreciated that other loss thresholds can be selected, e.g., −90 dB. However, as the loss threshold is lowered the uncertainty of determining a distance between the SCR 100 and the transmission source 301 increases. Additionally, rather than having a first and a second distance, more distance estimates can be determined. For example, a line of sight path loss equation can be used as follows:
PL=−(32.44+20*LOG(D)/3.25/1000)+20*LOG(f)),

where PL (path loss) is determined from the RSSI reading of step 202, f is the known carrier frequency of the RF signal, and D is the distance to the transmission source 301. Using this equation it can assumed that the best signal the SCR 100 receives would be a line of sight signal. Although this equation can provide more distance estimates than the two-distance approach mentioned above, the knee-curvature of path loss shown FIG. 12 illustrates that a minor change in a path loss reading (e.g., −100 dB) can change distance estimates substantially. Accordingly, certainty of a distance estimate should be factored when determining how many distance estimates are used.

In step 212, the distance 302 measured in step 201 can be used to calculate an approximate location of the SCR 100 relative to the known position of the transmission source 301. The approximate location of the SCR 100 in turn can be used in step 214 by the SPS receiver 104 as a reference position to accelerate the determination of a location fix of the SCR 100.

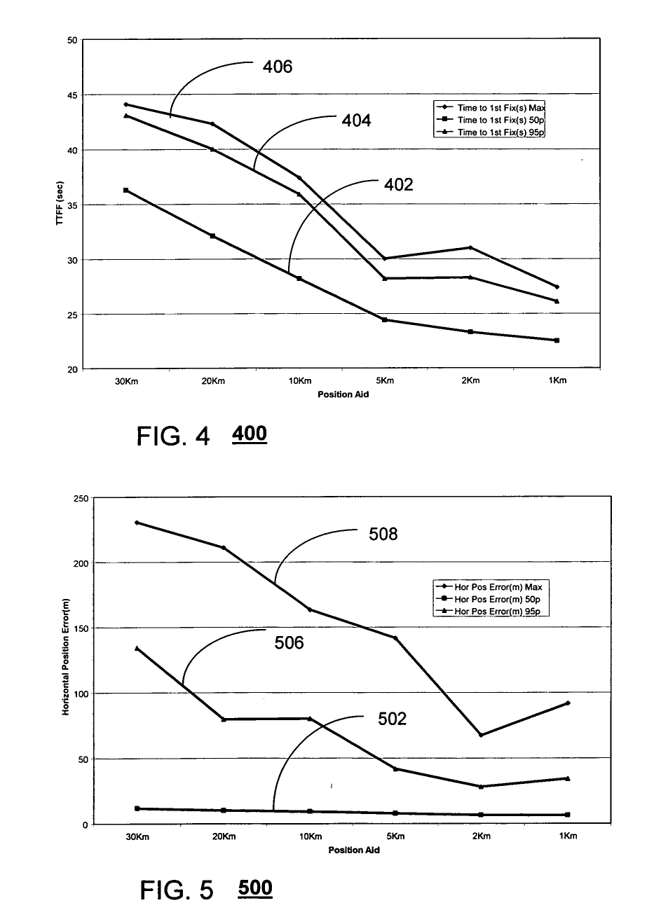

FIG. 4 shows a graph 400 depicting the time to first fix (TTFF) for several probability distributions 402-406 according to an embodiment of the present invention. From FIG. 4 the improvement in TTFF performance becomes evident as the approximate position uncertainty of the SCR 100 decreases. For example, at a distance 302 of 30 Km the first 4 SV (four satellite vehicle) fix is 36 seconds for a 50-percentile distribution curve 402. For the same curve at distance 302 of 1 Km, the TTFF is 22 seconds, an improvement of 14 seconds. This improvement is due to the search window being minimized and correlation occurring faster. Note that there is minimal improvement below 5 Km uncertainty.

The approximate location 302 of the SCR 100 also provides other improvements in determining a location fix in step 214. For example, in FIG. 5 shows 50%, 95% and 100% distributions 502-508 for the horizontal position error with the aid of the approximate location 302 of the SCR 100 calculated in step 212. As the uncertainty of the approximate location 302 of the SCR 100 improves the location fix determined in step 214 also improves. There is a more noticeable trend in the 95^{th} percentile distribution 506 with fewer position outliers. This type of result greatly improves the performance of the SPS receiver 104, and leads to a more stable system.

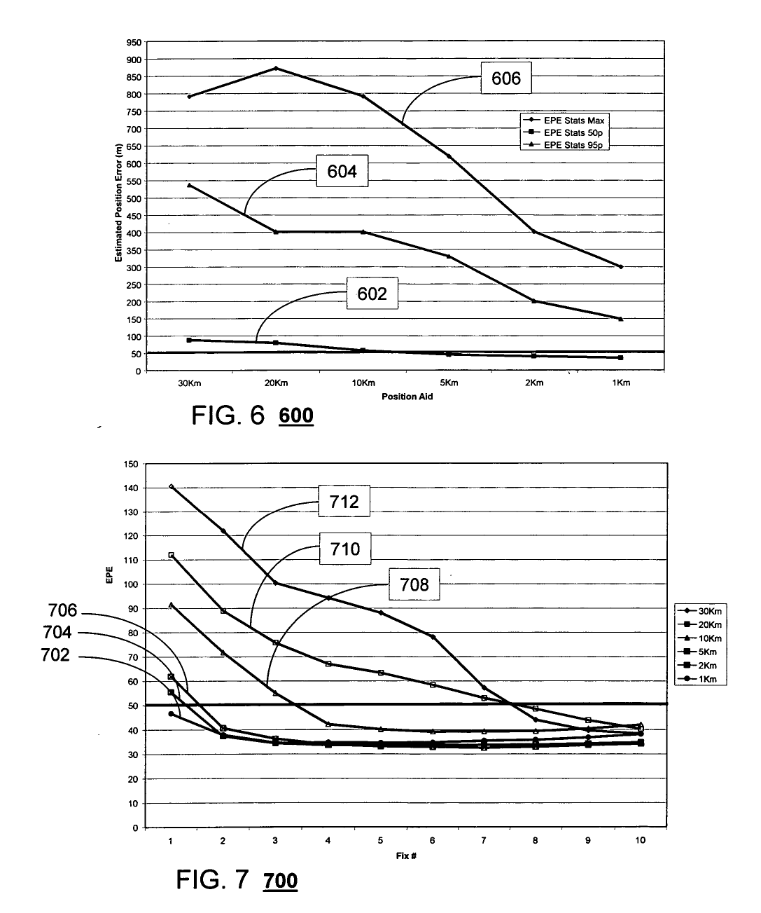

FIG. 6 shows 50%, 95% and 100% (maximum) distribution curves 602-608 for the estimated position error (EPE). As shown, the EPE improves with the aid of the approximate location 302 determined in step 212. The trend is more obvious in the maximum and the 95^{th} percentile distribution curves 606 and 604, respectively. This is similar to the results of the horizontal position error of FIG. 5 depicting less outliers. At an RF signal level of 26 dBHz (approximately −142 dBm), and at an approximate location of 5 Km, the EPE on the first 4 SV fix is blow 50 m.

To review the EPE on a location fix by location fix basis, all EPE's for the first 4 SV fixes are averaged from the 2^{nd} fix up to the 10^{th} fix for every session. This data is compared against approximate position uncertainty. The results are shown in FIG. 7, which depicts distribution curves 702-712 from 1 Km to 30 Km as shown in the legend. The data in FIG. 7 shows that by the 10^{th} location fix all curves 702-712 converge to very similar numbers below 50 m. The convergence is not the same for all approximate position estimates. The better the uncertainty of the approximate position 302 the better the convergence. Additionally, there is no significant difference below the 5 Km approximate position aid. This type of convergence shows that at a 30 Km approximate position estimate of the SCR 100 will have to wait an additional 8 seconds before the EPE drops below 50 m before the acquired position can be used. If the uncertainty of the approximate position 302 is lower, for example 5 Km, then the 2^{nd} fix would have been usable at a threshold of 50 m. This is an additional 7 second improvement in TTFF.

In a supplemental embodiment, method 200 can be improved with steps 216-222. In step 216, the location fix of step 214 can be stored in the memory 108 as a prior location fix. In step 218, a duration is measured between a start time of determining a new location fix and the prior location fix. From this duration a travel distance of the SCR 100 can be determined. The travel distance can be computed according to a velocity of the SCR 100 and the duration. In a first embodiment, the travel velocity can be estimated by the SCR 100 by conventional means such as by gross changes in position of the SCR 100 tracked by conventional triangulation means. Alternatively, a maximum velocity (e.g., 120 mph) can be established to address a worst-case scenario. The travel distance can then be calculated from an estimated distance traveled plus the EPE at the estimated distance (see FIGS. 3 and 6). Once a travel distance has been estimated, it is compared to an uncertainty threshold in step 220. The uncertainty threshold can be a distance parameter such as, for example, 30 Km—the maximum range of the transmission source 301.

For example, a fixed velocity of 120 mph or 2 miles/min can be assumed as the travel velocity of the SCR 100. Knowing that 30 Km is approximately 19 miles, it would take 9 minutes to reach a 30 Km boundary. Assume also a duration of 60 seconds is measured in step 218. Since 120 mph is approximately 54 m/sec, the SCR 100 would have traveled approximately 3.2 Km. Adding a typical EPE to this change in distance, it is evident that the result would most always be less than 30 Km. Hence, in step 222 the prior position fix would be used as an aid to the SPS receiver 104 to determine the new location fix. On the other hand, had the travel distance exceeded the uncertainty threshold (of 30 Km in this instance), then steps 201-214 can be repeated to aid the SPS receiver 104. The foregoing method can be used as a supplemental embodiment to improve the time to locate the SCR 100. Additionally, in portable applications, this method can be used to extend the duration between fixes to improve the battery life of the SCR 100 by shutting power by way of the power supply 112 to portions of the SCR 100 between location fixes.

It should be evident to the reader by now that the present invention can be realized in hardware, software, or a combination thereof. Additionally, the present invention can be embedded in a computer program executed by the processor 114 of the SCR 100, which comprises all the features enabling the implementation of the methods described herein, and which enables said SCR 100 to carry out these methods. A computer program in the present context means any expression, in any language, code or notation, of a set of instructions intended to cause a system having an information processing capability to perform a particular function either directly or after either or both of the following: a) conversion to another language, code or notation; b) reproduction in a different material form. Additionally, a computer program can be implemented in hardware as a state machine without conventional machine code as is typically used by CISC (Complex Instruction Set Computers) and RISC (Reduced Instruction Set Computers) processors.

It should also be evident that the present invention may be used for many applications. Thus, although the description is made for particular arrangements and methods, the intent and concept of the invention is suitable and applicable to other arrangements and applications not described herein. For example, the above descriptions refer to an SCR 100 operating according to the embodiments of method 200. Alternatively, method 200 can be applied to an SPS receiver 104 alone (i.e., operating an independent device). It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. In a satellite positioning system (SPS) receiver, a method comprising the steps of:
measuring a distance between the SPS receiver and a transmission source according to a radio frequency (RF) signal transmitted by the transmission source;
calculating an approximate location on Earth from the distance and a location of the transmission source; and
determining a location fix of the SPS receiver on Earth using the approximate location.

2. The method of claim 1, wherein the measuring step comprises the steps of:
from the transmission source,
supplying the SPS receiver a transmission power used by the
transmission source to transmit the RF signal;
supplying the SPS receiver the location of the transmission source;
at the SPS receiver,
determining a signal strength of the RF signal;
determining a path loss of the RF signal from the signal strength and
the transmission power; and
determining the distance between the SPS receiver and the
transmission source from the path loss.

3. The method of claim 1, wherein a transmission power used by the transmission source to transmit the RF signal, and the location of the transmission source are known to the SPS receiver, and wherein the measuring step comprises the steps of:
determining a signal strength of the RF signal;
determining a path loss of the RF signal from the signal strength and the transmission power; and
determining the distance between the SPS receiver and the transmission source from the path loss.

4. The method of claim 1, wherein the measuring step further comprises the steps of:
determining a path loss according to a signal strength of the RF signal and a transmission power of the transmission source;
comparing the path loss to a loss threshold;
determining the distance from a first distance when the path loss is above the loss threshold; and
determining the distance from a second distance when the path loss is below the loss threshold.

5. The method of claim 1, further comprises the steps of:
storing the location fix as a prior location fix;
measuring a duration between a start of determining a new location fix of the SPS receiver and the prior location fix;
determining a travel distance of the SPS receiver from the prior location fix;
repeating the steps of measuring a distance, calculating an approximate location, and determining a location fix when the travel distance exceeds an uncertainty threshold; and
determining the new location fix according to the prior location fix when the travel distance is below the uncertainty threshold.

6. The method of claim 5, wherein the travel distance is computed according to a travel velocity of the SPS receiver and the duration.

7. The method of claim 6, wherein the travel velocity is measured by the SPS receiver.

8. The method of claim 7, further comprising the steps of:
extending the duration between a prior location fix and a new location fix; and
shutting down power to a portion of the SPS receiver for the duration between the prior and new location fixes.

9. A satellite positioning system (SPS) receiver having a computer-readable storage medium, the storage medium comprising computer instructions for:
measuring a distance between the SPS receiver and a transmission source according to a radio frequency (RF) signal transmitted by the transmission source;
calculating an approximate location on Earth from the distance and a location of the transmission source; and
determining a location fix of the SPS receiver on Earth using the approximate location.

10. The storage medium of claim 9, wherein the measuring step comprises computer instructions for:
from the transmission source,
supplying the SPS receiver a transmission power used by the
transmission source to transmit the RF signal;
supplying the SPS receiver the location of the transmission source;
at the SPS receiver,
determining a signal strength of the RF signal;
determining a path loss of the RF signal from the signal strength and the transmission power; and
determining the distance between the SPS receiver and the transmission source from the path loss.

11. The storage medium of claim 9, wherein a transmission power used by the transmission source to transmit the RF signal, and the location of the transmission source are known to the SPS receiver, and wherein the measuring step comprises computer instructions for:
determining a signal strength of the RF signal;
determining a path loss of the RF signal from the signal strength and the transmission power; and
determining the distance between the SPS receiver and the transmission source from the path loss.

12. The storage medium of claim 9, wherein the measuring step further comprises computer instructions for:
determining a path loss according to a signal strength of the RF signal and a transmission power of the transmission source;
comparing the path loss to a loss threshold;
determining the distance from a first distance when the path loss is above the loss threshold; and
determining the distance from a second distance when the path loss is below the loss threshold.

13. The storage medium of claim 9, further comprises computer instructions for:
storing the location fix as a prior location fix;
measuring a duration between a start of determining a new location fix of the SPS receiver and the prior location fix;
determining a travel distance of the SPS receiver from the prior location fix;
repeating steps measuring a distance, calculating an approximate location, and determining a location fix when the travel distance exceeds an uncertainty threshold; and
determining the new location fix according to the prior location fix when the travel distance is below the uncertainty threshold.

14. The storage medium of claim 13, wherein the travel distance is computed according to a travel velocity of the SPS receiver and the duration.

15. The storage medium of claim 14, wherein the travel velocity is measured by the SPS receiver.

16. The storage medium of claim 15, further comprising computer instructions for:
extending the duration between a prior location fix and a new location fix; and
shutting down power to a portion of the SPS receiver for the duration between the prior and new location fixes.

17. A selective call radio (SCR), comprising:
a radio transceiver for exchanging messages with a communication system;
an SPS receiver for locating the SCR on Earth;
a display for conveying images to a user of the SCR;
an audio system for conveying audible signals to the user of the SCR;
a memory; and
a processor for controlling operations of the memory, the radio transceiver and the SPS receiver, wherein the processor is programmed to:
measure from the radio transceiver a distance between the SCR and a transmission source of the communication system according to a radio frequency (RF) signal transmitted by the transmission source;
calculate an approximate location on Earth from the distance and a location of the transmission source; and
cause the SPS receiver to determine a location fix of the SCR on Earth using the approximate location.

18. The SCR of claim 17, wherein the transmission source supplies the SCR a transmission power used by the transmission source to transmit the RF signal and the location of the transmission source, and wherein the processor is further programmed to:
cause the radio transceiver to determine a signal strength of the RF signal;
determine a path loss of the RF signal from the signal strength and the transmission power; and
determine the distance between the SPS receiver and the transmission source from the path loss.

19. The SCR of claim 17, wherein the measure step the processor is further programmed to:
cause the radio transceiver to determine a path loss according to a signal strength of the RF signal and a transmission power of the transmission source;
compare the path loss to a loss threshold;
determine the distance from a first distance when the path loss is above the loss threshold; and
determining the distance from a second distance when the path loss is below the loss threshold.

20. The SCR of claim 17, wherein the processor is further programmed to:
cause the memory to store the location fix as a prior location fix;
measure a duration between a start of determining a new location fix of the SPS receiver and the prior location fix;
determine a travel distance of the SPS receiver from the prior location fix;
repeat the steps of measuring a distance, calculating an approximate location, and causing the SPS receiving to determine a location fix when the travel distance exceeds an uncertainty threshold; and
cause the SPS receiver to determine the new location fix according to the prior location fix when the travel distance is below the uncertainty threshold.
